(19) United States
(12) Patent Application Publication
(10) Pub. No.: US 2013/0023279 A1
(43) Pub. Date: Jan. 24, 2013

(54) SYSTEMS AND METHODS FOR HANDLING TIME-RELATED ISSUES REGARDING SMS COMMUNICATIONS

(71) Applicant: Tai Cheung POON, Hong Kong (HK)

(72) Inventor: Tai Cheung POON, Hong Kong (HK)

(21) Appl. No.: 13/185,735

(22) Filed: Jul. 19, 2011

(51) Int. Cl. H04W 4/12; H04W 4/00

(52) U.S. Cl. 455/456.1; 455/466

(57) ABSTRACT

A SMS time management system is provided for handling time-related issues. The system, in one embodiment, comprises a SMS server; a GSM modem coupled to the SMS server, wherein the GSM modem is configured to send SMS messages instructed by the SMS server through a telephone network; a SMSC server located in a telephone operator, wherein the SMSC server is configured to receive, store, and deliver the SMS messages through the telephone network, and wherein: the SMSC server is connected to the SMS server through an IP network, communicating with each other by SMS messages via the IP network; a mobile phone representing a first user; a mobile phone representing a second user; a mobile phone representing a third user; a processor included in the SMS server; a memory included in the SMS server, wherein the memory storing instructions to cause the process to execute a method, the method comprising: receiving a request to send a SMS message from a first user, wherein content of the SMS message relates to starting a meeting at a time of a first time zone; and sending the SMS message to a second user, wherein the content of the SMS message is changed by the mobile device of the second user from starting the meeting at the time of the first time zone to starting the meeting at a time of a second time zone, in view of a location detected by a location detection device included in the mobile device of the second user.

### FIELD OF THE INVENTION

This invention generally relates to systems and methods for handling time-related issues regarding SMS communications. Specifically, but without limitation, this invention relates to time-related issues regarding SMS communications between users.

### BACKGROUND OF THE INVENTION

Nowadays, SMS (Short Message Service) messages are used extensively by many people, no matter if they are for business use or casual use. One reason for SMS popularity is its simple application. Unlike email messaging, SMS messages can be read by most mobile phones. Even though the size of a SMS is limited to a fixed number of characters, SMS transmission is extremely lightweight and thus efficient for sending certain short messages or notifications between a sender and a receiver. One popular use of these short messages is invitation to upcoming events. In these messages, time, place, and other meeting details are provided by the person who initiates an invitation that is called an organizer. The person, who is invited into an invitation, is called an invitee. The invitee, when received an invitation to an upcoming event, may join the invitation to the event, at the scheduled time and place. A SMS can be used domestically. For example, a friend who lives in one area may be asked another friend living in the same area to join a sightseeing event. In the process, the invitation details would be provided in the SMS message, such as the venue and time to meet. Such information can be clear and concise, as both parties are very familiar with the context of the details of the invitation. A SMS message can be used internationally. And such a use can create a lot of communication problems. In some cases, confusion may arise. For example, a telephone conference may be setup between two coworkers residing in different time zones. One, for instance, may reside in France, whereas the other resides in the United States. The organizer may want to start a meeting tomorrow at 10:00 France time. A SMS may then be sent to the other side with content included showing: “Telephone conference schedule at 10:00 France Time.” In such a case, the receiver to the message is required to make a judgment regarding the exact time of the teleconference. The receiver, in the process, needs to account for the location of himself or herself, the location of the sender, as well as any requisite summer/winter time zone adjustments, in order to ensure the exact time to join the conference, as indicated in the SMS message. This process may be complicated to many people, especially, to frequent business travelers. Also, if the calculation is wrong, the receiver may be mistakenly joining the conference at a different time. The impact can be substantial, if the conference or meeting is an important one that cannot be missed. A better solution, therefore, needs to be provided. In the above case, to say the least, the intent of the sender is clear with respect to its message, in terms of time and location of the meeting. There are times that messages of such kind can be puzzling to a reader. As yet another example, a SMS message may include: “Telephone conference scheduled at 10:00.” When read in a local context, in which case both the reader unanimously understands the time of 10:00 refer to the same time zone residing by both parties, no confusion would arise. However, going back to the prior example where one sender lives in France while the other living in the United States, which time zone does the 10:00 refer to? In any words, would the conference be held at 10:00 U.S. time, or 10:00 France time? Thus, a better solution should be provided. In view of the foregoing, to avoid confusing messages being received by the receiver, there is a need to detect confusing messages when such circumstances arise. There is a need to even to provide clarification to those messages when circumstances like these arise.

### SUMMARY OF THE INVENTION

A SMS time management system for handling time-related issues is provided, comprising a SMS server; a GSM modem coupled to the SMS server, wherein the GSM modem is configured to send SMS messages instructed by the SMS server through a telephone network; a SMSC server located in a telephone operator, wherein the SMSC server is configured to receive, store, and deliver the SMS messages through the telephone network, and wherein the SMSC server is connected to the SMS server through an IP network, communicating with each other by SMS messages via the IP network; a mobile phone representing a first user; a mobile phone representing a second user; a mobile phone representing a third user; a processor included in the SMS server; a memory included in the SMS server, wherein the memory storing instructions to cause the process to execute a method.

Consistent with embodiments of the invention, the inventive method receives a request to send a SMS message from a first user, wherein content of the SMS message relates to starting a meeting at a time of a first time zone; and sending the SMS message to a second user, wherein the content of the SMS message is changed by the mobile device of the second user from starting the meeting at the time of the first time zone to starting the meeting at a time of a second time zone, in view of a location detected by a location detection device included in the mobile device of the second user.

In another embodiment, the method may comprises receiving a request to send a SMS message from a first user, wherein content of the SMS message relates to starting a meeting at a time, whereas the content further provides that the time refers to a local time of the first user but without specifically naming a time zone of the first user detecting the SMS message from the first user being a possible confusing message; requesting the first user for confirmation regarding the exact time zone of the first user, wherein the request includes a time zone in view of a phone number of the first user and a time zone in view of a location detected by a location detection device included in the mobile device of the first user; editing the SMS message from the first user, after receiving the confirmation from the first user; and sending the SMS message to a second user.

Alternatively, the embodied method may include receiving a request to send a SMS message from a first user, wherein content of the SMS message relates to starting a meeting at a time without providing information with respect to a time zone of the meeting; detecting the SMS message from the first user being a possible confusing message; requesting the first user for confirmation regarding the exact time zone of the meeting, wherein the request includes a time zone in view of a phone number of the first user, a time zone in view of a location detected by a location detection device included in the mobile device of the first user, and a time zone in view of a location belonging to a second user who is a receiver of the SMS message; editing the SMS message from the first user, only after receiving the confirmation from the first user; and sending the SMS message to the second user. Further, the inventive method comprises receiving a request to send a SMS message from a first user to a second user, wherein content of the SMS message relates to starting a meeting at a time without providing information with respect to a time zone of the meeting, and wherein both the first and second user are in same time zone, in view of locations detected by the mobile devices of both users and in view of phone numbers of both users; detecting the SMS message from the first user being a confusion-free message, as both users are in the same time zone; and sending the SMS message to the second user.

In another embodiment, the embodied method comprises receiving a request to send a SMS message from a first user to a second user and a third user, wherein content of the SMS message relates to starting a meeting at a time without providing information with respect to a time zone of the meeting, and wherein both the first and second users are in same time zone, whereas both the first and third users are in different time zones, in view of locations detected by the mobile devices of both users and in view of phone numbers of both users; detecting the SMS message from the first user to the second user being a confusion-free message, as both users are in the same time zone; sending the SMS message to the second user; detecting the SMS message from the first user to the third user being a potential confusing message, as both the first and third users are in different time zones; requesting the first user for confirmation regarding the exact time zone of the meeting, wherein the request includes a time zone in view of a phone number of the first user, a time zone in view of a location detected by a location detection device included in the mobile device of the first user, and a time zone in view of a location belonging to a second user who is a receiver of the SMS message; editing the SMS message from the first user, only after receiving the confirmation from the first user, and sending the SMS message to the third user.

The inventive method may alternatively comprise receiving a request to send a SMS message from a first user to a second user and a third user, wherein content of the SMS message relates to starting a meeting at a time, whereas a time zone of the time of the meeting is provided in the SMS message, wherein both the first and second users are in a same time zone, whereas both the first and third users are in different time zones, in view of locations detected by the mobile devices of both users and in view of phone numbers of both users; detecting the SMS message from the first user to the second user being a confusion-free message, as both users are in the same time zone; sending the SMS message to the second user; detecting the SMS message from the first user to the third user being a potential confusing message, as both the first and third users are in different time zones; editing the SMS message from the first user to change the content of the SMS message so that the time zone of the meeting is changed to the time zone of the third user, in view of a location detected by a location detection device of the mobile device of the third user and a phone number of the third user; and sending the SMS message to the third user, after the editing is completed.

### BRIEF DESCRIPTION OF THE DRAWINGS

FIG. 1 illustrates an exemplary system to handle time-related issues of SMS.

### DETAILED DESCRIPTION

A SMS time management system is provided for handling time-related issues. Embodiments of the invention include a SMS server (100); a GSM modem coupled to the SMS server (100), wherein the GSM modem (110) is configured to send SMS messages instructed by the SMS server (100) through a telephone network; a SMSC server located in a telephone operator.

The features of this invention are explained in the context of a restaurant reservation system as described below. This embodiment is but one of many and is not intended to be limiting in any way.

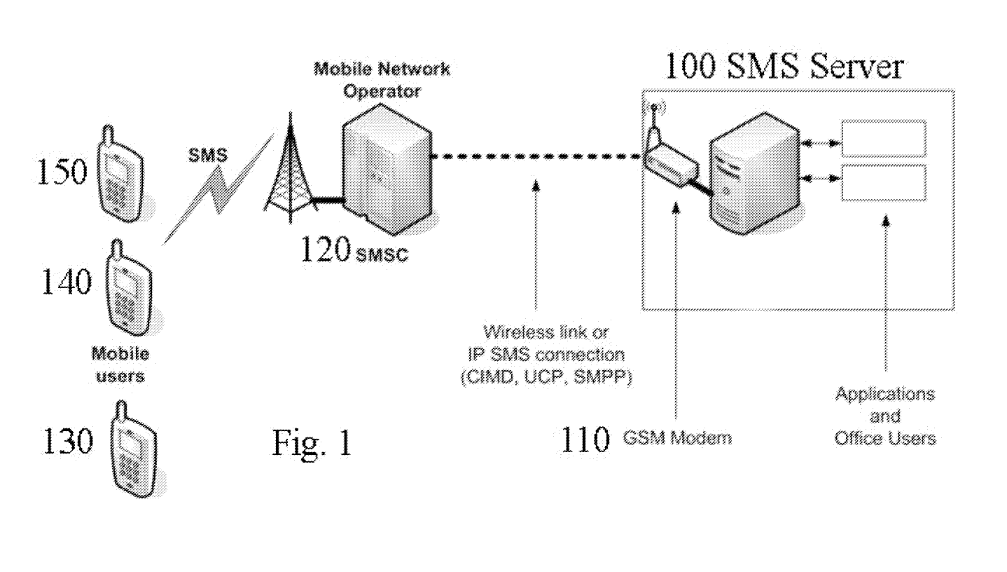

FIG. 1 refers to a SMS time management system. The system includes a SMSC server, which is configured to receive, store, and deliver the SMS messages through the telephone network, and wherein: the SMSC server is connected to the SMS server (100) through an IP network, communicating with each other by SMS messages via the IP network; a mobile phone representing a first user; a mobile phone representing a second user; a mobile phone representing a third user; a processor included in the SMS server (100); a memory included in the SMS server (100), wherein the memory storing instructions to cause the process to execute a method, the method comprising: receiving a request to send a SMS message from a first user, wherein content of the SMS message relates to starting a meeting at a time of a first time zone; and sending the SMS message to a second user, wherein the content of the SMS message is changed by the mobile device of the second user from starting the meeting at the time of the first time zone to starting the meeting at a time of a second time zone, in view of a location detected by a location detection device included in the mobile device of the second user.

Alternatively, one aspect of the inventions include a SMS server (100); a GSM modem (110) coupled to the SMS server (100), wherein the GSM modem (110) is configured to send SMS messages instructed by the SMS server (100) through a telephone network; a SMSC server located in a telephone operator, wherein the SMSC server is configured to receive, store, and deliver the SMS messages through the telephone network, and wherein the SMSC server is connected to the SMS server (100) through an IP network, communicating with each other by SMS messages via the IP network; a mobile phone representing a first user; a mobile phone representing a second user; a mobile phone representing a third user; a processor included in the SMS server (100); a memory included in the SMS server (100), wherein the memory storing instructions to cause the process to execute a method, the method comprising receiving a request to send a SMS message from a first user; and sending the SMS message to a second user.

In a different implementation, a SMS server (100) is included. Further, a GSM modem (110) is coupled to the SMS server (100), wherein the GSM modem (110) is configured to send SMS messages instructed by the SMS server (100) through a telephone network; a SMSC server (120) located in a telephone operator, wherein the SMSC server (120) is configured to receive, store, and deliver the SMS messages through the telephone network, and wherein the SMSC server (120) is connected to the SMS server (100) through an IP network, communicating with each other by SMS messages via the IP network; a mobile phone representing a first user; a mobile phone representing a second user; a mobile phone representing a third user; a processor included in the SMS server (100); a memory included in the SMS server (100), wherein the memory storing instructions to cause the process to execute a method, the method comprising receiving a request to send a SMS message from a first user, wherein content of the SMS message relates to starting a meeting at a time of a first time zone; and sending the SMS message to a second user, wherein the content of the SMS message is changed by the mobile device of the second user from starting the meeting at the time of the first time zone to starting the meeting at a time of a second time zone, in view of a location detected by a location detection device included in the mobile device of the second user.

In yet another implementation, the SMSC server (120) is located in a telephone operator, wherein the SMSC server (120) is configured to receive, store, and deliver the SMS messages through the telephone network, and wherein the SMSC server (120) is connected to the SMS server (100) through an IP network, communicating with each other by SMS messages via the IP network; a mobile phone representing a first user; a mobile phone representing a second user; a mobile phone representing a third user; a processor included in the SMS server (100); a memory included in the SMS server (100), wherein the memory storing instructions to cause the process to execute a method, the method comprising receiving a request to send a SMS message from a first user, wherein content of the SMS message relates to starting a meeting at a time, whereas the content further provides that the time refers to a local time of the first user but without specifically naming a time zone of the first user; detecting the SMS message from the first user being a possible confusing message; requesting the first user for confirmation regarding the exact time zone of the first user, wherein the request includes a time zone in view of a phone number of the first user and a time zone in view of a location detected by a location detection device included in the mobile device of the first user; editing the SMS message from the first user, after receiving the confirmation from the first user; and sending the SMS message to a second user.

In yet another implementation, the inventive method comprises receiving a request to send a SMS message from a first user, wherein content of the SMS message relates to starting a meeting at a time without providing information with respect to a time zone of the meeting; detecting the SMS message from the first user being a possible confusing message; requesting the first user for confirmation regarding the exact time zone of the meeting, wherein the request includes a time zone in view of a phone number of the first user, a time zone in view of a location detected by a location detection device included in the mobile device of the first user, and a time zone in view of a location belonging to a second user who is a receiver of the SMS message; editing the SMS message from the first user, only after receiving the confirmation from the first user; and sending the SMS message to the second user.

In yet another implementation, the request is made to send a SMS message from a first user to a second user, wherein content of the SMS message relates to starting a meeting at a time without providing information with respect to a time zone of the meeting, and wherein both the first and second user are in same time zone, in view of locations detected by the mobile devices of both users and in view of phone numbers of both users; detecting the SMS message from the first user being a confusion-free message, as both users are in the same time zone; and sending the SMS message to the second user.

Further, the method can comprises receiving a request to send a SMS message from a first user to a second user and a third user, wherein content of the SMS message relates to starting a meeting at a time without providing information with respect to a time zone of the meeting, and wherein both the first and second users are in same time zone, whereas both the first and third users are in different time zones, in view of locations detected by the mobile devices of both users and in view of phone numbers of both users; detecting the SMS message from the first user to the second user being a confusion-free message, as both users are in the same time zone; sending the SMS message to the second user; detecting the SMS message from the first user to the third user being a potential confusing message, as both the first and third users are in different time zones; requesting the first user for confirmation regarding the exact time zone of the meeting, wherein the request includes a time zone in view of a phone number of the first user, a time zone in view of a location detected by a location detection device included in the mobile device of the first user, and a time zone in view of a location belonging to a second user who is a receiver of the SMS message; editing the SMS message from the first user, only after receiving the confirmation from the first user and sending the SMS message to the third user.

Another aspect of the inventive system includes receiving a request to send a SMS message from a first user to a second user and a third user, wherein content of the SMS message relates to starting a meeting at a time, whereas a time zone of the time of the meeting is provided in the SMS message, wherein both the first and second users are in a same time zone, whereas both the first and third users are in different time zones, in view of locations detected by the mobile devices of both users and in view of phone numbers of both users; detecting the SMS message from the first user to the second user being a confusion-free message, as both users are in the same time zone; sending the SMS message to the second user; detecting the SMS message from the first user to the third user being a potential confusing message, as both the first and third users are in different time zones; editing the SMS message from the first user to change the content of the SMS message so that the time zone of the meeting is changed to the time zone of the third user, in view of a location detected by a location detection device of the mobile device of the third user and a phone number of the third user; and sending the SMS message to the third user, after the editing is completed.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A SMS time management system for handling time-related issues, comprising:
a SMS server;
a GSM modem coupled to the SMS server, wherein the GSM modem is configured to send SMS messages instructed by the SMS server through a telephone network;
a SMSC server located in a telephone operator, wherein the SMSC server is configured to receive, store, and deliver the SMS messages through the telephone network, and wherein:
the SMSC server is connected to the SMS server through an IP network, communicating with each other by SMS messages via the IP network;
a mobile phone representing a first user;
a mobile phone representing a second user;
a mobile phone representing a third user;
a processor included in the SMS server; and
a memory included in the SMS server, wherein the memory storing instructions to cause the process to execute a method.

2. The system of claim 1, wherein the method comprises:
receiving a request to send a SMS message from a first user, wherein content of the SMS message relates to starting a meeting at a time of a first time zone; and
sending the SMS message to a second user, wherein the content of the SMS message is changed by the mobile device of the second user from starting the meeting at the time of the first time zone to starting the meeting at a time of a second time zone, in view of a location detected by a location detection device included in the mobile device of the second user.

3. The system of claim 2, wherein the method comprises:
receiving a request to send a SMS message from a first user, wherein content of the SMS message relates to starting a meeting at a time, whereas the content further provides that the time refers to a local time of the first user but without specifically naming a time zone of the first user;
detecting the SMS message from the first user being a possible confusing message;
requesting the first user for confirmation regarding the exact time zone of the first user, wherein the request includes a time zone in view of a phone number of the first user and a time zone in view of a location detected by a location detection device included in the mobile device of the first user;
editing the SMS message from the first user, after receiving the confirmation from the first user; and
sending the SMS message to a second user.

4. The system of claim 1, wherein the method comprises:
receiving a request to send a SMS message from a first user, wherein content of the SMS message relates to starting a meeting at a time without providing information with respect to a time zone of the meeting;
detecting the SMS message from the first user being a possible confusing message;
requesting the first user for confirmation regarding the exact time zone of the meeting, wherein the request includes a time zone in view of a phone number of the first user, a time zone in view of a location detected by a location detection device included in the mobile device of the first user, and a time zone in view of a location belonging to a second user who is a receiver of the SMS message;
editing the SMS message from the first user, only after receiving the confirmation from the first user; and
sending the SMS message to the second user.

5. The system of claim 1, wherein the method comprises:
receiving a request to send a SMS message from a first user to a second user, wherein content of the SMS message relates to starting a meeting at a time without providing information with respect to a time zone of the meeting, and wherein both the first and second user are in same time zone, in view of locations detected by the mobile devices of both users and in view of phone numbers of both users;
detecting the SMS message from the first user being a confusion-free message, as both users are in the same time zone; and
sending the SMS message to the second user.

6. The system of claim 1, wherein the method comprises:
receiving a request to send a SMS message from a first user to a second user and a third user, wherein content of the SMS message relates to starting a meeting at a time without providing information with respect to a time zone of the meeting, and wherein both the first and second users are in same time zone, whereas both the first and third users are in different time zones, in view of locations detected by the mobile devices of both users and in view of phone numbers of both users;
detecting the SMS message from the first user to the second user being a confusion-free message, as both users are in the same time zone;
sending the SMS message to the second user;
detecting the SMS message from the first user to the third user being a potential confusing message, as both the first and third users are in different time zones;
requesting the first user for confirmation regarding the exact time zone of the meeting, wherein the request includes a time zone in view of a phone number of the first user, a time zone in view of a location detected by a location detection device included in the mobile device of the first user, and a time zone in view of a location belonging to a second user who is a receiver of the SMS message;
editing the SMS message from the first user, only after receiving the confirmation from the first user; and
sending the SMS message to the third user.

7. The system of claim 1, wherein the method comprises:
receiving a request to send a SMS message from a first user to a second user and a third user, wherein content of the SMS message relates to starting a meeting at a time, whereas a time zone of the time of the meeting is provided in the SMS message, wherein both the first and second users are in a same time zone, whereas both the first and third users are in different time zones, in view of locations detected by the mobile devices of both users and in view of phone numbers of both users;
detecting the SMS message from the first user to the second user being a confusion-free message, as both users are in the same time zone;
sending the SMS message to the second user;
detecting the SMS message from the first user to the third user being a potential confusing message, as both the first and third users are in different time zones;
editing the SMS message from the first user to change the content of the SMS message so that the time zone of the meeting is changed to the time zone of the third user, in view of a location detected by a location detection device of the mobile device of the third user and a phone number of the third user; and
sending the SMS message to the third user, after the editing is completed.
